(19) United States
(12) Patent Application Publication
(10) Pub. No.: US 2009/0033622 A1
(43) Pub. Date: Feb. 5, 2009

(54) Smartscope/smartshelf

(75) Inventor: Alex J. Kalpaxis, Glendale, NY (US)

Correspondence Address: VENABLE LLP, P.O. BOX 34385, WASHINGTON, DC, 20043-9998, US

(73) Assignee: 24/8 LLC, Waterbury, CT (US)

(21) Appl. No.: 12/155,254

(22) Filed: May 30, 2008

Related U.S. Application Data
(60) Provisional application No. 60/924,735, filed on May 30, 2007.

(51) Int. Cl. G06F 3/033

(52) U.S. Cl. 345/158

(57) ABSTRACT

The SmartScope technology implements perceptual interfaces with a focus on machine vision and establishes a footprint for data collection based on the field of view of the data collecting device. The SmartScope implemented in a retail environment integrates multiple perceptual modalities such as computer vision, speech and sound processing, and haptic (feedback) Input/Output) into the customer's interface. The SmartScope computer vision technology will be used as an effective input modality in human computer interaction (HCI).

### BACKGROUND OF THE INVENTION

Embodiments of the present invention relate to systems and methods for monitoring and interacting with customers in a retail environment.

### SUMMARY OF THE INVENTION

Embodiments of the invention provide an apparatus comprising an interface a communication channel coupled to the interface to transfer information between a customer and system, the information relating to at least two of the following modalities: a vision modality; an audio modality; a touch modality; a smell modality; and a taste modality, a processing engine to combine the at least two modalities to facilitate a purchase by the customer.

### BRIEF DESCRIPTION OF THE DRAWINGS

FIG. 1 is a block diagram illustrating the communication flow between a customer and the smartscope/smartshelf according to an exemplary embodiment of the present invention; and

FIG. 2 is a block diagram illustrating a high level architecture view of a system according to an exemplary embodiment of the present invention.

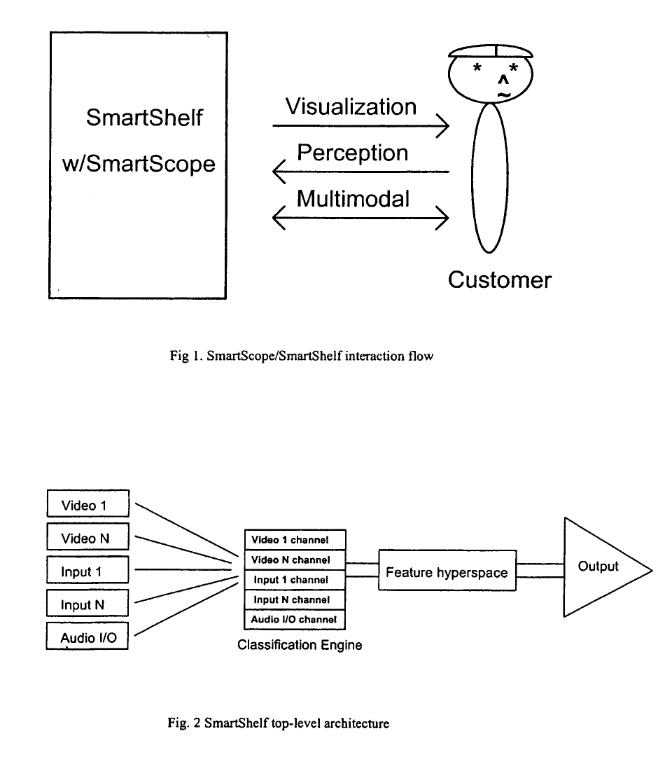

### DETAILED DESCRIPTION OF AN EXEMPLARY EMBODIMENT

The SmartScope technology implements perceptual interfaces with a focus on machine vision and establishes a footprint for data collection based on the field of view of the data collecting device. The SmartScope implemented in a retail environment integrates multiple perceptual modalities such as computer vision, speech and sound processing, and haptic (feedback) Input/Output) into the customer's interface. The SmartScope computer vision technology will be used as an effective input modality in human computer interaction (HCI). The SmartScope's specific SmartShelf objective(a retailer's product shelf that implements SmartShelf hardware and software such as video CCD cameras and embedded analytics computing platforms/controllers), in using perceptual interfaces, is that they are highly interactive, multi-modal interfaces that enable rich, natural, and efficient interaction with SmartShelf. SmartShelf seeks to leverage sensing (input) and rendering (output) technologies in order to provide interactions not feasible with standard interfaces and the common Input/Output devices that have been attempted such as using the keyboard, mouse, and monitor. Keyboard-based alphanumeric input and mouse-based 2D pointing and selection is very limiting for a SmartShelf's retail type of application and in some cases awkward and inefficient modes of interaction. Neither mouse nor keyboards are appropriate for communicating 3D information or the subtleties of the shopping experience.

The SmartShelf technology provides an interface that is more natural, intuitive, adaptive, and unobtrusive for the next generation retail applications. The SmartShelf technology leverages small, powerful, connected sensing and display technologies that allow for creating interfaces that enable natural human capabilities to communicate via speech, gesture, expression, touch, etc. SmartShelf will also complement existing interaction styles and enable new functionality not otherwise possible or convenient. The SmartShelf technology implementation incorporates design criteria that is focused on time to train/learn, performance, error rate, retention over time, and subjective satisfaction. Additionally, by positioning the recording device out of the subject's plain sight and establishing an innocuous footprint of data collection, SmartShelf will accommodate all customer diversity on the interactive portion of the system. customers have diverse set of abilities, backgrounds, motivations, and personalities. customers have a range of perceptual, cognitive, and motor abilities and limitations. In addition, different cultures produce different perspectives and styles of interaction, a significant issue for current international markets. customers with various kinds of disabilities, elderly users, female/male adults and children all have distinct preferences or requirements to enable a positive user experience.

SmartShelf technology creates a highly interactive environment which is not a passive interface that waits for customers to enter commands before taking any action. SmartShelf actively senses and perceives the shopping environment and takes action based on goals and knowledge at various levels. SmartShelf is an active interface that uses passive and non-intrusive sensing. SmartShelf is multi-modal, supporting multiple perceptual modalities such as vision, audio, and touch in both directions. That is, from SmartShelf to the customer and from the customer to SmartShelf. The SmartShelf interfaces move beyond the limited modalities and channels available with a standard keyboard, mouse, and monitor to take advantage of a wider range of modalities, either sequentially or in parallel. SmartShelf fully supports multi-modal, multimedia and recognition-based interfaces.

The customer's interaction with the SmartShelf technology will be unintrusive, social and natural. Typically, a customer's social response is automatic and unconscious and can be elicited by just basic cues. customers will usually show social responses to cues regarding manners and politeness, personality, emotion, gender, trust, ethics, and other social aspects. SmartShelf speech recognition, natural language processing, speech synthesis, discourse modeling with dialogue management, in addition to word based speech, allows SmartShelf to recognizes, for example, a sneeze, a cough, a noisy environment, in order to enhance interactivity. The SmartShelf uses graphics and information visualization to provide a much more enhanced and richer function to communicate to the customer than is currently available. SmartShelf uses visual information to provide useful and important cues to interaction. The presence, location, and posture of a customer is important contextual information, where a gesture or facial expression can be a key signal. The direction of the customer's head and gaze allows SmartShelf to make initial determinations of levels of interest and actual product acquisition.

The SmartShelf technology multi-modal interface combines two or more input modalities in a coordinated manner. The SmartShelf perceptual interface is inherently multi-modal. customers interact with the retail experience by way of information being sent and received, primarily through the five major senses of sight, hearing, touch, taste, and smell. A modality refers to a particular sense. A communication channel is a pathway through which information is transmitted. A channel describes the interaction technique that utilizes a particular combination of customer and SmartShelf communication. The customer output/SmartShelf input pair or SmartShelf output/customer input pair can be based on a particular device, such as the keyboard channel or the mouse channel, or on a particular action, such as spoken language, written language, or dynamic gestures. As an example, the following are all channels: text, which may use multiple modalities when typing in text or reading text on a monitor, sound, speech recognition, images/video, and mouse pointing and clicking.

Input communicates to SmartShelf and output signifies communication from SmartShelf. Multi-modal interfaces focus on integrating sensor recognition-based input technologies such as speech recognition, gesture recognition, and computer vision, into the shopping interface. The function of each technology is better thought of as a channel than as a sensing modality, so that a multi-modal interface is one that uses multiple modalities to implement multiple channels of communication. Using multiple modalities to produce a single interface channel such as vision and sound to produce 3D customer location is multi-sensor fusion, not a multi-modal interface. Using a single modality to produce multiple channels such as a left-hand mouse to navigate and a right-hand mouse to select is a multi-channel interface, not a multi-modal interface.

SmartShelf supports a multi-modal system configuration that uses speech and gesturing to interact with map-based applications leveraging 3D visualization. Additionally, wireless handheld agent-based devices can be introduced that will support collaborative multi-modal system for interacting with distributed applications. SmartShelf will analyze continuous speech and gesturing in real time and produces a joint semantic interpretation using a statistical unification-based approach. The SmartShelf technology supports uni-modal speech or gesturing as well as multi-modal input.

The SmartShelf system permits the flexible use of input modes, including alternation and integrated use. SmartShelf supports improved efficiency, especially when manipulating multimedia information such as, graphical information. SmartShelf can support shorter and simpler speech utterances than a speech-only interface, which results in fewer state-machine errors and more robust speech recognition. The SmartShelf technology supports greater precision of spatial information as compared to a speech-only interface, since touch input can be very precise. SmartShelf will offer customers alternatives in their shopping interaction. SmartShelf will allow for enhanced error avoidance and ease of error resolution. SmartShelf accommodates a wider range of customers, tasks, and environmental situations. The SmartShelf technology is adaptable during continuously changing environmental conditions. The SmartShelf accommodates individual customer differences, such as, permanent or temporary handicaps. The SmartShelf technology can help prevent overuse of any individual customer mode during extended SmartShelf usage.

The SmartScope vision/image technology using several feature extraction and recognition algorithms for face recognition, gaze direction analysis, and gesture analysis. One such SmartScope recognition algorithm is skin color properties analysis, where the appearance of skin color varies mostly in intensity while the chrominance remains fairly consistent. Color spaces that separate intensity from chrominance, such as the HSV color space, are better suited to skin segmentation when simple threshold-based segmentation approaches are used. The SmartScope vision/image skin color properties analysis algorithm performs the classification with a histogram-based method in RGB color space. Threshold methods and linear filters are used when HSV space analysis is performed. The SmartScope vision/image technology technology incorporates learning-based, nonlinear models in color space (such as N8). The SmartScope vision/image technology utilizes the continuously adaptive mean shift algorithm to dynamically parameterize a threshold based segmentation that can deal with a certain amount of lighting and background changes. Together with other video features such as motion, patches, or blobs of uniform color, this will allow SmartScope to segment skin-colored objects from backgrounds.

The SmartShelf vision/image technology processes infrared light to segment human body parts from most backgrounds, and that is energy from the infrared light portion of the electromagnetic spectrum. All objects constantly emit heat as a function of their temperature in form of infrared radiation, which are electromagnetic waves in the spectrum from about 700 nm, which is visible red light, to about 1 mm, that are microwaves. The human body emits the strongest signal at about 10 μm, which is long wave infrared light or thermal infrared. Not many common background objects emit strongly at this frequency in modest environments, so it is easy to segment body parts given a camera that operates in this spectrum. Using active illumination with short-wave infrared light, the body reflects it just like visible light, so the illuminated body part appears much brighter than background scenery to a camera that filters out all other light. This is done for short-wave infrared light because most digital imaging sensors are sensitive to this part of the spectrum. Consumer digital cameras require a filter that limits the sensitivity to the visible spectrum to avoid unwanted effects. Color information can be used on its own for body part localization, or it can create attention areas to direct other methods, and/or it can serve as a validation and “second opinion” about the results from other multi-cue approaches. Statistical color as well as location information is used in the context of Bayesian probabilities.

The SmartScope vision/image technology incorporates an edge and shape detection algorithm for determining shape properties of objects. The SmartScope uses fixed shape models, such as an ellipse for head detection, and/or rectangles for body limb tracking, thus minimizing the summative energy function from probe points along the shape. At each probe, the energy is lower for sharper edges in the intensity or color image. The shape parameters which are size, ellipse foci, and rectangular size ratio are continually adjusted with an efficient, iterative portion of the algorithm until a local minimum is reached. The SmartScope edge and shape detection algorithm incorporates processes that yield unconstrained shapes, which operate by connecting local edges to global paths. From these sets, paths are selected as candidates for recognition that resemble a desired shape as much as possible. Further more, the SmartScope edge and shape detection algorithm also utilize statistical shape models based on the active shape model process. The statistical shape model process learns about deformations from a set of training shapes. This information is used in the recognition phase to register the shape to deformable objects. Geometric moments are computed over entire images and/or over select points such as a contour.

The SmartScope vision/image technology incorporates optical motion flow algorithm that matches a region from one frame to a region of the same size in the following frame. The motion vector for the region center is defined as the best match in terms of some distance measure such as least-squares difference of the intensity values. The SmartScope optical motion flow algorithm uses parametric data for both the size of the region feature as well as the size of the search neighborhood. The SmartScope optical motion flow algorithm uses pyramids for faster, hierarchical optical flow computation which is more efficient for large between-frame motions. The resulting optical flow field describes the movement of entire scene components in the image plane over time. Within these fields, motion blobs are defined as pixel areas of uniform motion with similar speed and direction. With static camera positions, motion blobs are used for object detection and tracking.
A) SmartScope/SmartShelf device can determine the customer is a member of the retailers frequent customer program.
B) SmartScope/SmartShelf can determine the customer is in a calm or agitated state
C) SmartScope/SmartShelf can determine the “customer” is on a list of “individuals to watch” because of some previously documented undesirable activity.
D) SmartScope/SmartShelf can determine the customer is interested in special offer listed in the retailer's circular.
E) SmartScope/SmartShelf can direct a customer through the accumulation of items or pieces needed to complete a project or shopping for a specific event (What does the customer need to build a fence and/or everything the customer needs for their tailgate party for 20 people)
F) SmartScope/SmartShelf records the customer's individual traffic patterns
G) SmartScope/SmartShelf can profile the customer's interactions with products based on existing emotional state within this retailer
H) SmartScope/SmartShelf can provide the customer an unprecedented amount of service and relevant information customized for them
I) The retailer can boost revenue by selling business intelligence generated by SmartScope/SmartShelf, thus creating new revenue streams
J) SmartScope/SmartShelf can provide product location/resulting sells data to allow the retailer to increase product “slotting fees” to product vendors.

1-2. (canceled)

3) An apparatus, comprising:
an interface
a communication channel coupled to the interface to transfer information between a customer and system, the information relating to at least two of the following modalities:
a vision modality;
an audio modality;
a touch modality;
a smell modality; and
a taste modality
a processing engine to combine the at least two modalities to facilitate a purchase by the customer.

4) The apparatus of claim 3, wherein the processing engine further comprises a visioning engine for face recognition, gaze direction analysis, gesture analysis, motion flow, and infrared image analysis.
